(19) United States
(12) Patent Application Publication
(10) Pub. No.: US 2022/0346592 A1
(43) Pub. Date: Nov. 3, 2022

(54) PASTA BINDING VESSEL AND METHOD

(71) Applicant: Kenneth Michael Bryson, Charlotte, NC (US)

(72) Inventor: Kenneth Michael Bryson, Charlotte, NC (US)

(21) Appl. No.: 17/661,192

(22) Filed: Apr. 28, 2022

Related U.S. Application Data
(60) Provisional application No. 63/180,970, filed on Apr. 28, 2021.

(51) Int. Cl. A47J 36/20; A47J 27/00; A21C 9/00; A47J 36/02; A23L 5/10; A23L 7/109

(52) U.S. Cl. CPC A47J 36/20; A47J 27/00; A21C 9/00; A47J 36/025; A23L 5/13; A23L 7/109; A47J 2027/006; A23V 2002/00

(57) ABSTRACT

A pasta binding vessel includes a base, a mating lid, and a closure component. The base is a sheet with shaped troughs. The lid is linear and/or has a shape mirroring the troughs. The vessel binds long pasta together as it cooks, preserving the cohesion of the pasta noodles. A method of producing bonded pasta includes inserting elongated pasta into the pasta binding vessel; closing the pasta binding vessel; submerging the pasta binding vessel into boiling water; cooking the pasta for a predetermined period; removing the pasta binding vessel from the boiling water; cooling the pasta for a predetermined period; opening the pasta binding vessel; and removing the bonded pasta from the pasta binding vessel. The pasta is rigid enough to be cut into manageable pieces and dunked into sauce or used as “edible toothpicks” inserted into items such as meatballs, shrimp, and chicken.

### CROSS-REFERENCE TO RELATED APPLICATION

This application claims the benefit of priority of U.S. provisional application No. 63/180,970, filed Apr. 28, 2021, the contents of which are herein incorporated by reference.

### BACKGROUND OF THE INVENTION

The present invention relates to pasta preparation devices and, more particularly, to a pasta binding vessel and method.

Spaghetti and meatballs require dexterity to eat without making a mess. Pasta is a particularly difficult dish for some dexterity-challenged individuals, such as small children and the elderly.

As can be seen, there is a need for a means of enabling dexterity-challenged individuals to eat pasta products easily and neatly.

### SUMMARY OF THE INVENTION

In one aspect of the present invention, a pasta binding vessel comprises an elongated perforated channel having a closure component, wherein the elongated perforated channel has a tubular sidewall with a cross sectional shape selected from the group consisting of: circular, oval, triangular, square, rectangular, diamond, and rounded polygonal.

In another aspect of the present invention, a pasta binding vessel comprises a base, a mating lid, and a closure component, wherein the base is a first sheet having a plurality of troughs with a cross-sectional shape selected from the group consisting of: semi-circular, semi-oval, semi-triangular, semi-square, semi-rectangular, semi-diamond, and semi-rounded polygonal; and the mating lid is a second sheet having a cross section selected from the group consisting of: linear, a shape mirroring the cross-sectional shape of the plurality of troughs, and a combination thereof.

In another aspect of the present invention, a method of producing a bonded pasta article, comprises inserting elongated pasta into a pasta binding vessel comprising an elongated perforated channel having a closure component; closing the pasta binding vessel; submerging the pasta binding vessel into boiling water; cooking the pasta for a predetermined time period; removing the pasta binding vessel from the boiling water; cooling the pasta for a predetermined time period; opening the pasta binding vessel; and removing the bonded pasta article from the pasta binding vessel.

These and other features, aspects and advantages of the present invention will become better understood with reference to the following drawings, description, and claims.

### BRIEF DESCRIPTION OF THE DRAWINGS

FIG. 1 is a perspective view of a pasta binding vessel according to an embodiment of the present invention, shown in use;

FIG. 2 is another perspective view thereof;

FIG. 3 is an exploded view thereof;

FIG. 4 is a front view thereof;

FIG. 5 is a perspective view of a pasta binding vessel according to another embodiment of the present invention, shown in use;

FIG. 6 is another perspective view thereof;

FIG. 7 is an exploded view thereof; and

FIG. 8 is a front elevation view thereof.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a pasta binding vessel and a cooking process therefor to produce a bound cooked pasta article.

Due to its ingredients, commercially available pasta (e.g., purchased from national retail grocers) produces a sticky residue which, if restricted and contained during the cooking process, adheres the noodles to each other. The inventive vessels bind long pasta together as it cooks, preserving the cohesion of the pasta noodles.

By following a preparation process according to the present invention, the noodles fully cook and combine to form a unitary finger food instead of a collection of individual noodles. The resulting pasta article remains straight after it cools. Once cooled, the straight bound pasta article is rigid enough to be cut into manageable pieces and dunked into sauce. Narrower pasta articles may be used as “edible toothpicks” that may be inserted into items such as meatballs, shrimp, and chicken.

The binding vessels may be individual perforated tubes or may be a continuous sheet of multiple adjacent semi-tubular vessels, e.g., having an elongated perforated channel. The tubes may have a tubular sidewall with a cross-sectional shape selected from but not limited to: circular, oval, triangular, square, diamond, and rounded polygonal. Preferably, the vessel is a mated pair of continuous or unitary sheets of adjacent semi-circular tubes, having a predetermined distance between the tubes to enhance water circulation. The continuous sheet may have a trough with a semi-circular (i.e., half-circle), semi-oval (i.e., half-oval), semi-triangular (i.e., half-triangle or 2 of three legs, for example), semi-square (i.e., half-square), semi-rectangular (i.e., half-rectangle), semi-diamond (i.e., half-diamond), and semi-rounded polygonal (i.e., half-semi-rounded polygon) cross-section. The mating lid may have a linear cross section; a plurality of peaks with a cross sectional shape mirroring the cross-sectional shape of the plurality of troughs; or a combination thereof.

Cooked pasta may be removed from the inventive vessel without compromising the structure of the pasta article. In some embodiments, the vessel may have a hinged side. Alternatively, the vessel may have individual separable components or may be unrolled or unfolded to remove the pasta article. The vessel may have closure means, such as a closure component to keep separable components together and/or to keep the pasta within the vessel during cooking. Without intending to be limiting, the closure component may be selected from the group consisting of clasps, clamps, magnetic closures, and the like.

The device may have a handle joined thereto. For example, the handle may be attached to the vessel with a flange and/or stabilizer and may be operative to keep the vessel upright inside of a receiving pot.

The inventive vessel may be placed into a receiving pot in which to cook the pasta. The pot may be multi-troughed with one or more side walls or may be a large open pot. The pot may be either a commercially available stove top-heated pot or a stand-alone electrical appliance. The stand-alone electrical appliance may plug into a residential power outlet.

The materials of manufacture are not particularly limited. The inventive vessels may be made of heat resistant, food safe, rigid materials such as stainless steel or aluminum. A tubular vessel may have a stainless steel or aluminum sidewall with open ends. Preferably an interior of the vessels is coated with any suitable non-stick material. The non-stick interior surface may prevent the pasta from sticking to the sides.

The dimensions of the inventive vessel are not particularly limited. The vessels are preferably slightly longer than commercially available pasta noodles (i.e., roughly 10 inches long or about 5 inches for half-length pasta). An exemplary unitary sheet may have overall dimensions of about 12 inches by about 12 inches, with about a 1-inch separation between tubes having a tube diameter of about 19.05 mm.

The method of manufacture is not particularly limited. Vessels may be formed from a sheet of perforated material by any suitable means, such as molding or folding and punching.

The inventive vessel may be used by loading a predetermined amount of elongated pasta into the vessel and submerging it in boiling water for a predetermined time. Once the pasta is fully cooked, it may be cooled and permitted to rest, ensuring the integrity of the formed pasta article.

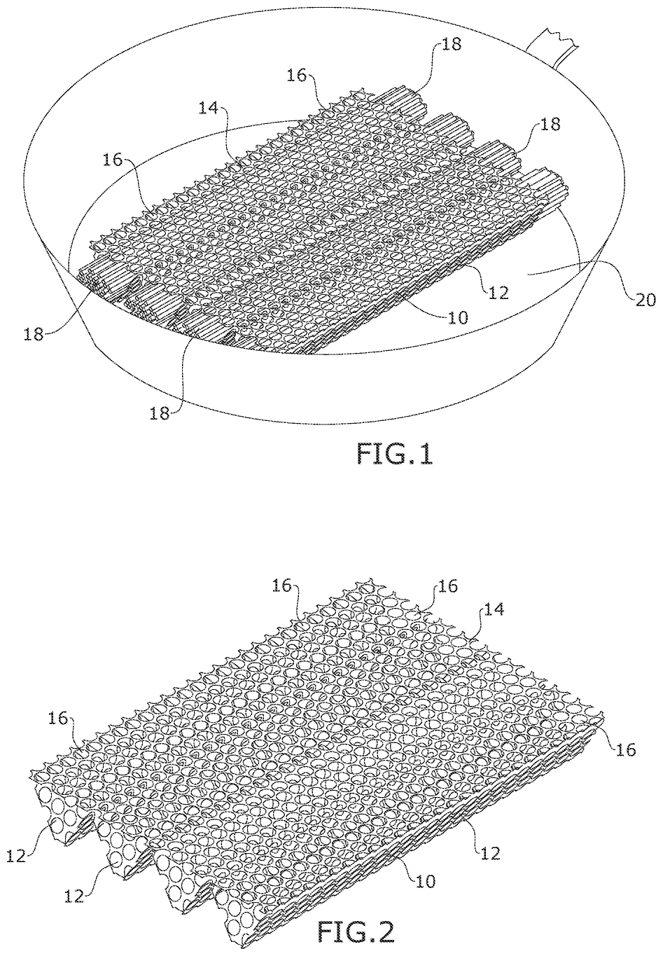

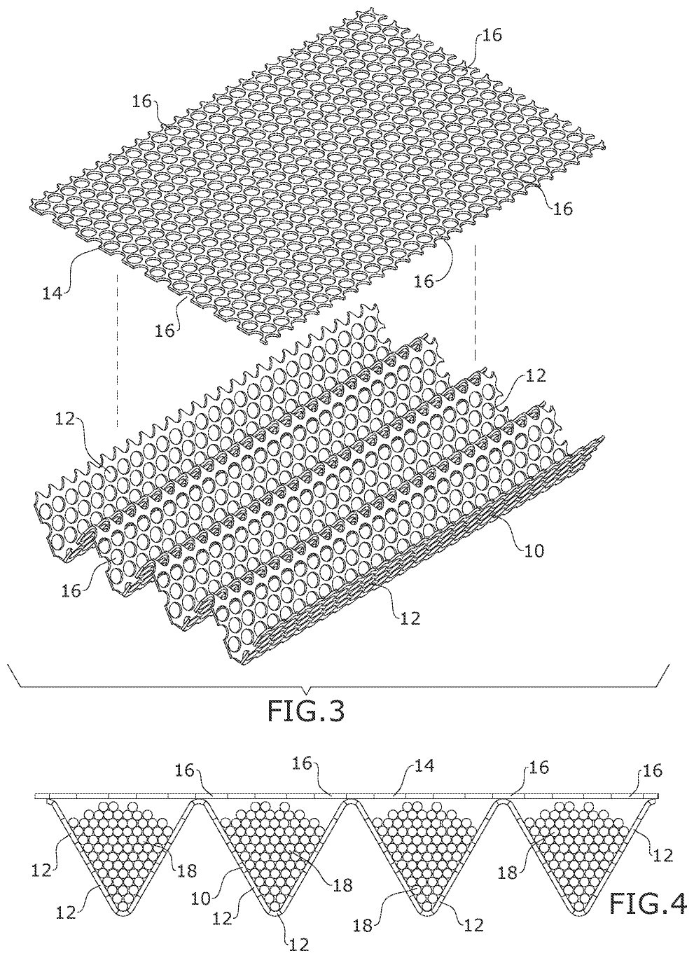

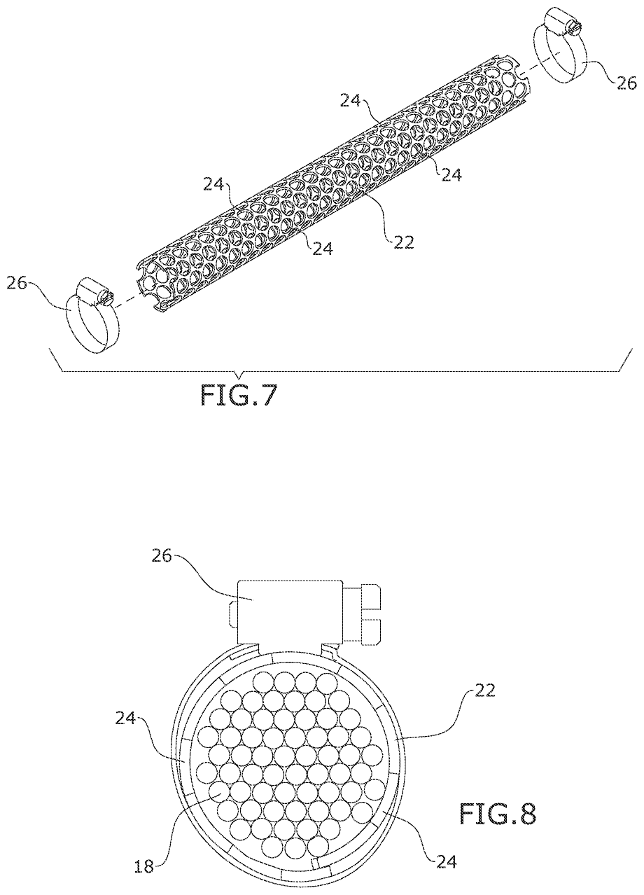

Referring to FIGS. 1 through 8, FIGS. 1 through 4 illustrate a multi-tube pasta binding vessel according to an embodiment of the present invention comprising a base or tray 10 having perforations 12 and a lid 14 having perforations 16. As shown in FIG. 1, noodles 18 may be placed in the tray 10, covered with the lid 14, and immersed in boiling water in a pan 20. The lid 14 may be attached to the tray 10 by any suitable closure means (not shown). Once the pasta 18 is cooked and cooled, the lid 14 may be lifted and the bonded pasta article may be removed from the tray 10.

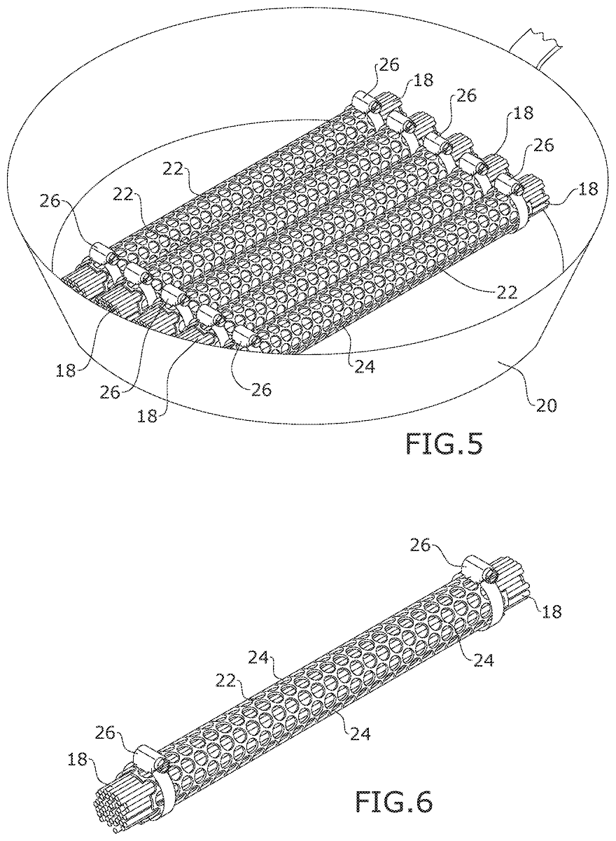

FIGS. 5 through 8 illustrate an individual pasta binding tube 22 having perforations 24. Pasta 18 may be securely retained within the tube 22 with a clamp 26, such as a hose clamp or any other suitable closure means. A plurality of tubes 22 may be immersed in boiling water in a pan 20. Once the pasta 18 is cooked and cooled, the clamp 26 may be removed and the tube may be slightly unrolled to remove the bonded pasta product. As shown in FIG. 8, the tubular sidewall may have an overlapped portion or a separable seam at which the tube may be opened, enabling removal of the pasta 18.

While FIGS. 1 through 4 illustrate a substantially triangular tube and FIGS. 5 through 8 illustrate a substantially circular tube, the inventive vessels are not so limited. For example, the tray and lid may form a plurality of spaced substantially circular tubes.

It should be understood, of course, that the foregoing relates to exemplary embodiments of the invention and that modifications may be made without departing from the spirit and scope of the invention as set forth in the following claims.

What is claimed is:

1. A pasta binding vessel, comprising an elongated perforated channel having a closure component, wherein the elongated perforated channel has a tubular sidewall with a cross sectional shape selected from the group consisting of: circular, oval, triangular, square, rectangular, diamond, and rounded polygonal.

2. The pasta binding vessel of claim 1, wherein the sidewall comprises stainless steel or aluminum and has a non-stick interior surface.

3. The pasta binding vessel of claim 1, wherein the closure component is selected from the group consisting of a clasp, a clamp, and a magnetic closure.

4. The pasta binding vessel of claim 1, wherein the tubular sidewall is rolled or folded with a separable seam.

5. A pasta binding vessel, comprising a base, a mating lid, and a closure component, wherein the base is a first sheet having a plurality of troughs with a cross-sectional shape selected from the group consisting of: semi-circular, semi-oval, semi-triangular, semi-square, semi-rectangular, semi-diamond, and semi-rounded polygonal; and
wherein the mating lid is a second sheet having a cross section selected from the group consisting of: linear, a shape mirroring the cross-sectional shape of the plurality of troughs, and a combination thereof.

6. The pasta binding vessel of claim 5, having a non-stick interior surface.

7. The pasta binding vessel of claim 5, wherein the closure component is selected from the group consisting of a clasp, a clamp, and a magnetic closure.

8. A method of producing a bonded pasta article, comprising:
a. inserting elongated pasta into a pasta binding vessel comprising an elongated perforated channel having a closure component;
b. closing the pasta binding vessel;
c. submerging the pasta binding vessel into boiling water;
d. cooking the pasta for a predetermined time period;
e. removing the pasta binding vessel from the boiling water;
f. cooling the pasta for a predetermined time period;
g. opening the pasta binding vessel; and
h. removing the bonded pasta article from the pasta binding vessel.
